(19) United States
(12) Patent Application Publication
(10) Pub. No.: US 2009/0228351 A1
(43) Pub. Date: Sep. 10, 2009

(54) Method and Means for the Adminstration of a Distribution of Prizes

(76) Inventors: Rob A.W. Rijsenbrij, Haulerwijk (NL); Werner Bruhn, Garding (DE); Christian Ullmann, Westendorf (DE)

Correspondence Address: OLIFF & BERRIDGE, PLC, P.O. BOX 320850, ALEXANDRIA, VA, 22320-4850, US

(21) Appl. No.: 11/665,052

(22) PCT Filed: Oct. 14, 2004
(86) PCT No.: PCT/DE2004/002285

§ 371 Date: Sep. 30, 2008

(51) Int. Cl. G06Q 30/00; G06Q 20/00; H04M 3/42

(52) U.S. Cl. 705/14; 705/40; 455/414.1

(57) ABSTRACT

What is disclosed are a method for the administration of a distribution of prizes, for example in a lottery, and means for implementing the method, wherein merely a telecommunication number of the person wishing to participate in the distribution of prizes and a participation number allocated by the provider of the distribution of prizes are stored. A further identification of the participant only takes place in a case where the latter actually is to receive a win. Preferably the costs for participation in the distribution of prizes are deducted via a telecommunications invoice from the participant's account with a telecommunications network operator or provider, or such amount is deducted from pre-paid cards.

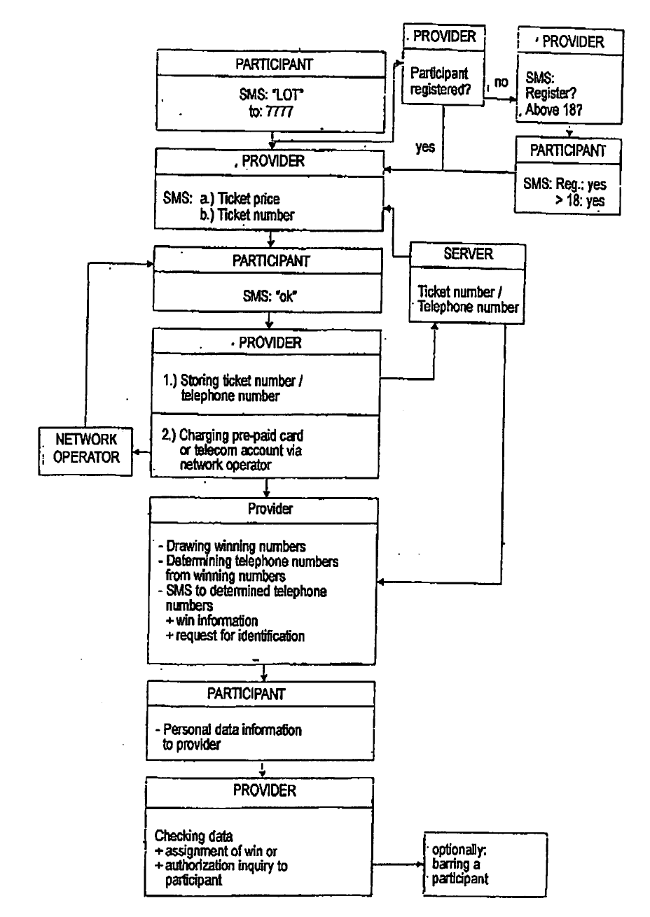

The invention relates to a method for the administration of a distribution of prizes in accordance with the preamble of claim 1, and means for implementing this method in accordance with claim 8.

Together with an improvement of data transfer rates and an optimization of the spatial coverage of fixed networks and mobile phone networks, more and more applications are also effected in the private domain by telephone or by data transmission of private terminals. Thus, e.g., the classical lottery game with manual filling in of a lottery ticket and submission and payment of this lottery ticket at a receiving office is replaced with “virtual” applications where the lottery ticket is submitted, for instance, via the internet or via SMS. Under the domain www.lotto-bayern.de a like virtual lottery game is offered, where it is possible to participate by SMS (Short Message Service). The participating person must initially fill in a registration whereby the specific personal data such as name, address, place of residence, etc. is noted down. Moreover it is necessary to establish a so-called betting account where it is i.a. necessary to indicate the banking information of the participating person.

The person thus registered is then enabled to play a lottery ticket by SMS and obtain information about the winning numbers by SMS. In the case of a win, the participating person receives an SMS informing about the win.

It is a problem in such manners of proceeding that the numbers of persons participating in these “virtual” games are increasing strongly, and very extensive provisions must thus be made by the provider in order to store the collected data and protect it against unauthorized access.

In contrast, the invention is based on the object of furnishing a method and a device whereby the distribution of prizes is simplified.

This object is attained through a method for the administration of a distribution of prizes having the features of claim 1, and by means having the features of independent claim 8.

In accordance with the invention, no individual data concerning the person are stored by the provider administering the distribution of prizes, but merely the telecommunications identification such as, e.g., the mobile phone number under which the participant has sent a message to the provider thereby indicating his wish to participate in the method. The participant then receives from the provider a participation number (ticket number) which is only linked with the individual telecommunications identification. I.e., in accordance with the invention the set of data to be stored is reduced to a fraction in comparison with the conventional solutions, so that in order to administer the distribution of prizes a memory space requirement substantially reduced in comparison with the known solutions is necessary. Besides the minimization of the memory space requirement and the concomitant simplification of the administration software and of the hardware, the solution in accordance with the invention has another essential advantage: as only a telecommunications identification is stored at the provider for determining the participation numbers benefiting from the distribution of prizes, misuse of participants' individual data by unauthorized third parties is practically excluded.

For the participant, the method in accordance with the invention provides the advantage that he may participate without any major complexity of administration, i.e., without any complex inputting of specific personal data by internet or by e-mail.

In one embodiment of the invention, settlement of the costs for participation in the method is effected via the telecommunications invoice of the telecommunications network operator of the one network to which the participant is customarily logged on. I.e., by this variant of the method, the safety of the method for the participant is enhanced quite substantially, for in order to participate in the method it is not necessary for him to disclose his banking connection. The method in accordance with the invention is also operable with pre-paid cards, for the costs for participation are then deducted directly from the pre-paid card. In principle, payment may also be effected via credit cards or debit cards, where it is necessary to link these cards with the telephone number and/or SIM card so as to allow to charge the costs incurred by the transaction to the card.

In a preferred variant of the invention, the participant sends a participation ID to the provider via a terminal, e.g. a mobile phone. The participant then receives from the provider a message—optionally by SMS—concerning the costs of participation as well as the participation number and a request to confirm participation.

Upon confirmation by the participant via the terminal used (mobile phone), participation in the method then takes place, with merely a set of data consisting of the ticket number and the telecommunications identification (in addition to the data prescribed by law) being stored in the provider's server.

In the case of a win, the participant is then informed via the telecommunications identification of the fact that he has won and only then, i.e., in the case of a win, has to indicate his personal data and/or a banking connection to which the win is to be transferred.

To this end, the participant must in one preferred embodiment of the invention contact a central registration facility which is, e.g., an internet portal, a call center or the like, so that the prize can be distributed to the participants.

The method in accordance with the invention is certainly not restricted to particular single telecommunications networks, but in the case of corresponding agreements between the telecommunications network operators and the providers of the distribution of prizes (lottery), the participants may be associated with various networks.

In an advantageous development of the method, only participants who were registered in advance can participate in the distribution of prizes. This registration does, however, advantageously only take place via the telecommunications identification and optionally—if prescribed by national law—through the confirmation that a particular minimum age, e.g. 18 years, has been attained. The specific age is not inquired or stored. Without registration it is not possible to participate in the method.

In accordance with the invention, the means for implementing the method comprise a server for storing the set of data consisting of the telecommunications identification and the participation number awarded by the provider, selection means for selecting beneficiary participation numbers benefiting from the distribution of prizes from the registered sets of data, and information means for issuing a message to the telecommunications identification linked with the selected participation number.

The means for implementing the method preferably include settlement means for charging the costs for participation in the method (purchase of ticket) from the participant's account held at the telecommunications network operator.

The means moreover include a persons data memory in which the beneficiary participation numbers benefiting from the distribution of prizes are stored.

Further advantageous developments of the invention are subject matter of additional subclaims.

In the following a preferred embodiment of the invention is explained in more detail by means of a schematic drawing.

The single FIGURE shows by way of the example of a lottery a flow chart illustrating the data flow of a method in accordance with the invention.

The correspondence between the participant (player) and the lottery company (provider) that is necessary for participation in the lottery shall be enacted by SMS in the embodiment described in the following.

Each participant must initially register, for which purpose an SMS containing a lottery ticket request is sent to the provider. The latter then asks by SMS or checks internally whether or not the participant has been registered. In the negative, the participant will be asked by the provider by SMS whether he has reached the minimum age prescribed by law. if this is affirmed, the telephone number is stored on the server. In the negative, the participant will not be registered while also not being able to buy a ticket. Purchase of a ticket following this registration takes place in the following manner.

In order to purchase a ticket, the participant sends an SMS including a password, for instance “lot” (corresponding to “ticket”), to a telephone number or ID number of the lottery company, e.g., the sequence of numbers “7777”.

The lottery company then sends by SMS a message to the participant, which message may have two parts in the represented embodiment. In the first part of the SMS, the costs of the lottery ticket are communicated; in the second part the participant receives the ticket number and the request to confirm participation in the lottery. At the same time, the lottery company stores the ticket number and the telephone number of the participant evident from the SMS as a set of data in a central server. It is not necessary to store additional particulars concerning the participant. For the case that this should be provided by national legislation, however, it is, of course, possible to store legally required data, such as the player's age, in addition to the two core data items (ticket number/telephone number). Nevertheless this shall only be done in order to satisfy the legal prescriptions while not being necessary for the administration of the lottery in accordance with the invention.

After the participant has declared consent to participation in the lottery by SMS, the above described set of data (ticket number/telephone number) is stored conclusively, and the costs for the lottery ticket are charged through the mobile phone network operator per telecommunications invoice, or deducted from the participant's pre-paid card. Herefor the lottery company will have concluded a cooperation agreement with all major mobile phone network operators and providers. This deduction of costs constitutes one advantage of the method, for the participant need not—like in the prior art described at the outset—disclose details of his banking connection vis-à-vis the lottery company.

At a predetermined time the winning numbers, i.e., the ticket numbers participating in the distribution of prizes, are then drawn by the lottery company, and the telephone numbers linked with the respective ticket numbers are then determined from the stored data. The winners then receive via the provider an SMS containing the message that they have drawn a “blank” or that they have won in the lottery and should contact a registration facility in order to identify themselves vis-à-vis the lottery company so that the prize may be paid out or—in cases of prizes in kind—delivered. In other words, in accordance with the invention the personal data of a participant, such as name, address, account number, etc. is acquired only in the case of a a win: for implementing the lottery proper up to payment of the win, only the two mentioned core data items (ticket number/telephone number and data prescribed by law) need to be administered.

The named registration facility may, for instance, be an internet portal to which the participant directs an e-mail containing his personal data. As an alternative, registration may be effected through the intermediary of a call center, by fax, or the like.

As the lottery will conclude cooperation agreements with a multiplicity of network operators, the circle of participants is not restricted to the users of a single network, but participants from a multiplicity of national mobile phone networks may take part, or also a Europe-wide draw with participants from various nations and respective different mobile phone networks may be carried out.

Where it should turn out in the final identification of the participant that the latter is a minor or does not satisfy other legal requirements, the lottery company will take corresponding measures to ensure that the win is not handed out to this one participant but to some other authorized person, such as the parents in the case of a participation by a minor. Moreover the respective telephone number may be inhibited internally by the company to preclude a repeated participation. It is, of course, possible for the lottery company to be informed in advance by third parties, such as by parents, that a particular telephone number is not allowed to participate in the lottery.

The participants can in addition obtain information through the intermediary of the provider's internet portal or the like about the winning ticket number, so that the win may also be queried if—despite repeated dispatch—the SMS containing the win message did not reach the participant or was overlooked by the latter.

It is moreover provided to restrict the maximum number of tickets per telephone number that may be purchased to a maximum number, e.g. four tickets per day, so that a misuse is substantially excluded.

In principle, the invention is not restricted to a utilization in mobile phone networks. It is also possible for participants—to the extent that this is technically viable—to participate via a fixed network or via a local network, such as a wireless LAN.

Instead of collecting the ticket costs via the telecommunications invoice or the pre-paid card, other cashless means of payment may also enter into consideration. For example the lottery company may have concluded an agreement with credit card enterprises, allowing credit card holders to have the costs deducted from the card, wherein, e.g., the telephone number and the PIN code are then used as an identification. The same manner of proceeding is also possible with debit cards.

What is disclosed are a method for the administration of a distribution of prizes, for example in a lottery, and means for implementing the method, wherein merely a telecommunication number of the person wishing to participate in the distribution of prizes and a participation number allocated by the provider of the distribution of prizes are stored. A further identification of the participant only takes place in a case where the latter actually is to receive a win. Preferably the costs for participation in the distribution of prizes are deducted via a telecommunications invoice from the participant's account with a telecommunications network operator or provider, or such amount is deducted from pre-paid cards.

1. A method for the administration of a distribution of prizes, wherein a participation request is sent to a provider by radio, preferably by mobile phone, or via fixed network, a participation number is allocated by the provider and stored in a server, and costs for participation are settled, and at least one beneficiary participation number is determined by the provider, and the respective participant is informed of the win, wherein each participant is linked with the allocated participation number through his individual telecommunications identification, preferably a mobile phone number, and stored on the server, and—besides legal requirements—an identification and storing of additional participant-specific data required for issue of the prize only takes place following selection of the beneficiary participation numbers.

2. The method in accordance with claim 1, wherein the costs for participation in the distribution of prizes are charged to the participant through the intermediary of an account held at the telecommunications network operator, a credit card account, a debit card account, or the like.

3. The method in accordance with claim 1, wherein the participant sends a participation ID to the provider via a terminal, a participation number is sent back to the terminal from the provider, the participation is confirmed, and then a message from the provider is sent to the winner, containing the request to identify himself at a central registration facility.

4. The method in accordance with claim 3, wherein the registration facility is an internet portal or a call center.

5. The method in accordance with claim 1, wherein the messages between participant and provider are sent by SMS (Short Message Service).

6. The method in accordance with claim 1, wherein the participants may be associated with various telecommunications networks.

7. The method in accordance with claim 1, wherein a preceding registration is provided at which the participant's telecommunications identification is stored and the attainment of a minimum age is checked.

8. Means for implementing the method for the distribution of prizes, in particular in accordance with claim 1, comprising:
a server for storing of set of data consisting of an individual telecommunications identification and a participation number linked therewith,
selection means for selecting beneficiary participation numbers from the registered sets of data, and
information means for issuing a message to the telecommunications identifications linked with the selected participation numbers.

9. The means in accordance with claim 8, including settlement means for charging the costs for participation via a telecommunications network operator.

10. The means in accordance with claim 8, including a persons data memory for acquiring and storing the data of the beneficiary participants following determination of the beneficiary participation numbers.
